(19) United States
(12) Patent Application Publication
(10) Pub. No.: US 2025/0315710 A1
(43) Pub. Date: Oct. 9, 2025

(54) QUANTUM COMPUTER UTILIZATION SUPPORT SYSTEM AND QUANTUM COMPUTER UTILIZATION SUPPORT METHOD

(71) Applicant: Hitachi, Ltd., Tokyo (JP)

(72) Inventors: Naoto SATO, Tokyo (JP); Takuro MORI, Tokyo (JP)

(73) Assignee: Hitachi, Ltd., Tokyo (JP)

(21) Appl. No.: 18/866,265

(22) PCT Filed: Feb. 9, 2023
(86) PCT No.: PCT/JP2023/004342

§ 371 Date: Nov. 15, 2024

(30) Foreign Application Priority Data
May 17, 2022 (JP) 2022-081083

(51) Int. Cl. G06N 10/60; G06N 10/70

(52) U.S. Cl. CPC G06N 10/60; G06N 10/70

(57) ABSTRACT

A quantum computer utilization support system 10 includes an operation apparatus 104 configured to specify, as quantum processes before transformation, a plurality of quantum processes similar to a quantum process to be processed, acquire information regarding a quantum process after transformation, a quantum calculation function, and a transform algorithm corresponding to each of the quantum processes before transformation, evaluate the quantum process after transformation on the basis of characteristics of the quantum calculation function, and select, as a quantum calculation function and a transform algorithm to be used in the quantum process to be processed, the quantum calculation function and the transform algorithm corresponding to the quantum process after transformation with the best evaluation result.

### TECHNICAL FIELD

The present invention relates to a quantum computer utilization support system and a quantum computer utilization support method.

### BACKGROUND ART

In recent years, practical use of a quantum computer is expected. However, with a quantum computer, errors may occur in the quantum bits due to physical noise. At present, it is difficult to completely correct these errors.

As a result, calculation results of the quantum computer may deviate significantly from theoretical values, that is, the fidelity may be low. In particular, when the theoretical values of the calculation results are not known or when the calculation results cannot be verified, there is a possibility that the calculation results may be used without anybody noticing that the fidelity of the calculation results is low.

Meanwhile, the type and the size (degree) of the error or the occurrence condition of the error that occurs in the quantum bits depends on the characteristics of the quantum computer. For example, an operator with a high error rate and an operator with a low error rate vary from one quantum computer to another.

In addition, although it is known that errors occur in quantum bits if the time from the start to the end of calculation is more than a certain time, that length of the time varies from one quantum computer to another.

Currently, several companies are developing quantum computers with different characteristics, and it is expected that these companies will provide quantum calculation functions of the quantum computers as cloud services. In this way, multiple quantum calculation functions implemented in quantum computers with different characteristics are expected to be provided, and it is desirable to be able to select a quantum calculation function that returns a calculation result with high fidelity according to the target quantum calculation processing.

An example of proposed conventional techniques related to the management of the fidelity described above includes a method and an apparatus for estimating the fidelity of quantum hardware (see Patent Document 1).

The technique relates to a method including a step of accessing a set of quantum gates, a step of sampling a subset of quantum gates from the set of quantum gates, the subset of the quantum gates defining a quantum circuit, a step of applying the quantum circuit to a quantum system and making a measurement on the quantum system to determine output information regarding the quantum system, a step of calculating output information regarding the quantum system on the basis of the application of the quantum circuit to the quantum system, and a step of estimating fidelity of the quantum circuit on the basis of the determined output information and the calculated output information regarding the quantum system.

### PRIOR ART DOCUMENTS

### Patent Documents

Patent Document 1: JP-2020-80173-A

### SUMMARY OF THE INVENTION

### Problem to be Solved by the Invention

Meanwhile, the quantum calculation processing includes a sequence of operators (gates) representing operations for quantum bits. In the technique illustrated in Patent Document 1, errors that occur in the execution of the operators are specified as characteristics of the quantum computer.

There is a possibility that the technique can be used to estimate the fidelity of the calculation result from the types and the number of operators included in the quantum calculation processing.

However, some quantum computers cannot execute a specific operator. In that case, the quantum calculation processing including the operator needs to be transformed (transpiled) into equivalent quantum calculation processing including another operator.

There are a large number of algorithms for such transformations. Therefore, the structure of the quantum calculation processing obtained as a result of the transformation varies in various ways depending on the transform algorithm. Furthermore, it is not apparent that which transform algorithm can be adopted to obtain a calculation result with high fidelity (transformed into quantum calculation processing with high fidelity).

That is, when a certain quantum calculation processing is given, whether a combination of a quantum calculation function and a transform algorithm is appropriate cannot be estimated unless the quantum calculation function and the transform algorithm are freely selected to actually execute the transformation.

In addition, when quantum calculation is used in part of an application, the time that can be used for the quantum calculation is also limited based on the response time requirement of the entire application. Therefore, it is difficult to execute all combinations of quantum calculation functions and transform algorithms to compare and evaluate the estimation results.

Eventually, an appropriate one of numerous combinations of the quantum calculation functions and the transform algorithms needs to be selected as a transform execution “candidate.”

In addition, the fidelity derived based on the operators included in the quantum calculation processing is merely an estimation result, and the fidelity may be different from the reality. Therefore, even if the quantum calculation function and the transform algorithm estimated to have high fidelity can be selected based on the configuration of the quantum calculation processing, a calculation result with high fidelity may not be actually obtained.

Accordingly, an object of the present invention is to provide a technique that can support selecting a combination of a quantum calculation function and a transform algorithm for obtaining a calculation result with high fidelity in quantum calculation processing.

### Solving the Problem

The present invention for solving the problem provides a quantum computer utilization support system including a storage apparatus that holds information regarding a quantum calculation function for executing a quantum process, an operator that can be executed by the quantum calculation function, a transform algorithm for transforming the quantum process into an equivalent quantum process after transformation including the operator, and a history of using the transform algorithm to transform a predetermined quantum process executed by a predetermined quantum calculation function into a quantum process after transformation, and an operation apparatus that executes a process of specifying, as quantum processes before transformation, a plurality of predetermined quantum processes similar to a quantum process to be processed from the history and acquiring information regarding the quantum process after transformation, the quantum calculation function, and the transform algorithm corresponding to each of the plurality of specified quantum processes before transformation from the history, a process of evaluating the quantum process after transformation acquired from the history, on the basis of characteristics of the quantum calculation function in the information acquired from the history, and a process of selecting, as a quantum calculation function and a transform algorithm to be used in the quantum process to be processed, the quantum calculation function and the transform algorithm corresponding to the quantum process after transformation with a best result of the evaluation.

In addition, the present invention provides a quantum computer utilization support method executed by an information processing apparatus, the information processing apparatus configured to hold, in a storage apparatus, information regarding a quantum calculation function for executing a quantum process, an operator that can be executed by the quantum calculation function, a transform algorithm for transforming the quantum process into an equivalent quantum process after transformation including the operator, and a history of using the transform algorithm to transform a predetermined quantum process executed by a predetermined quantum calculation function into a quantum process after transformation, and execute a process of specifying, as quantum processes before transformation, a plurality of predetermined quantum processes similar to a quantum process to be processed from the history and acquiring information regarding the quantum process after transformation, the quantum calculation function, and the transform algorithm corresponding to each of the plurality of specified quantum processes before transformation from the history, a process of evaluating the quantum process after transformation acquired from the history, on the basis of characteristics of the quantum calculation function in the information acquired from the history, and a process of selecting, as a quantum calculation function and a transform algorithm to be used in the quantum process to be processed, the quantum calculation function and the transform algorithm corresponding to the quantum process after transformation with a best result of the evaluation.

### Advantages of the Invention

The present invention can support selecting a combination of a quantum calculation function and a transform algorithm for obtaining a calculation result with high fidelity in quantum calculation processing.

### BRIEF DESCRIPTION OF THE DRAWINGS

FIG. 1 is a network configuration diagram including a quantum computer utilization support system of the present embodiment.

FIG. 2 is a diagram illustrating a hardware configuration example of a quantum program execution apparatus in the present embodiment.

FIG. 3 is a diagram illustrating a flow screen example of a quantum computer utilization support method in the present embodiment.

FIG. 4 is a diagram illustrating an example of a program and a quantum process in the present embodiment.

FIG. 5 is a diagram illustrating an evaluation instance of degrees of similarity in the present embodiment.

FIG. 6 is a diagram illustrating a transformation example with transform algorithms in the present embodiment.

FIG. 7 is a diagram illustrating a configuration example of quantum calculation function characteristic information in the present embodiment.

FIG. 8 is a diagram illustrating a selection method example of a quantum calculation function and a transform algorithm in the present embodiment.

FIG. 9 is a diagram illustrating the selection method example of the quantum calculation function and the transform algorithm in the present embodiment.

FIG. 10 is a diagram illustrating a computation example of estimated time in the present embodiment.

FIG. 11 is a diagram n illustrating an example of a calculation request target block in the present embodiment.

FIG. 12 is a diagram illustrating an execution result of quantum calculation and an evaluation example of the execution result in the present embodiment.

### DETAILED DESCRIPTION OF EMBODIMENTS

### <Network Configuration>

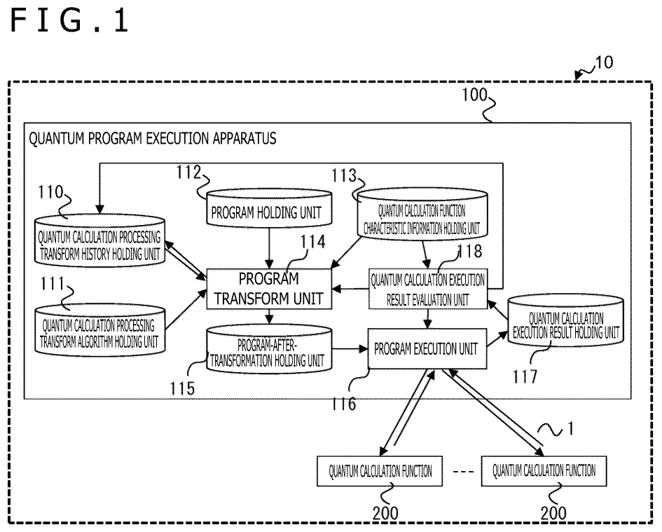

Hereinafter, an embodiment of the present invention will be described in detail with reference to the drawings. FIG. 1 is a network configuration diagram including a quantum computer utilization support system 10 of the present embodiment. The quantum computer utilization support system 10 illustrated in FIG. 1 is a computer system that can support selecting a combination of a quantum calculation function and a transform algorithm for obtaining a calculation result with high fidelity in quantum calculation processing.

The quantum computer utilization support system 10 of the present embodiment includes a quantum program execution apparatus 100 and quantum calculation functions 200 connected to each other and capable of communicating with each other through an appropriate network 1, such as the Internet, as illustrated in FIG. 1. Therefore, they may collectively be referred to as the quantum computer utilization support system 10.

The quantum program execution apparatus 100 of the present embodiment is an information processing apparatus that supports selecting a combination of a quantum calculation function and a transform algorithm to be used, in relation to a quantum program to be executed. The quantum program execution apparatus 100 inputs the quantum program to the quantum calculation function 200 chosen in the selection and obtains an execution result of the quantum program.

Meanwhile, the quantum calculation function 200 is a function of quantum calculation provided outside through the Internet by a company, an organization, or the like that operates a quantum calculation apparatus, and specifically, the quantum calculation function 200 is an apparatus that provides a quantum calculation service.

### <Hardware Configuration>

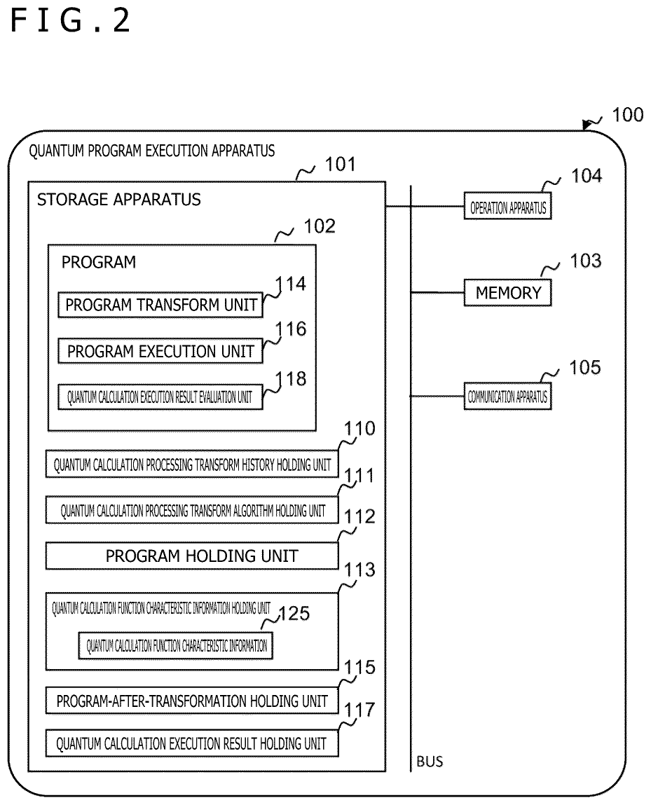

In addition, a hardware configuration of the quantum program execution apparatus 100 of the present embodiment is as illustrated in FIG. 2. That is, the quantum program execution apparatus 100 includes a storage apparatus 101, a memory 103, an operation apparatus 104, and a communication apparatus 105.

The storage apparatus 101 among them includes an appropriate non-volatile storage element, such as an SSD (Solid State Drive) and a hard disk drive.

In addition, the memory 103 includes a volatile storage element such as a RAM.

In addition, the operation apparatus 104 is a CPU that comprehensively controls the apparatus by, for example, reading a program 102 held in the storage apparatus 101 out to the memory 103 to execute the program 102 and that performs various types of determination, operation, and control processing.

The functions implemented by the execution of the program 102 by the operation apparatus 104 include a program transform unit 114, a program execution unit 116, and a quantum calculation execution result evaluation unit 118. In addition, an example of the communication apparatus 105 includes a network interface card connected to the network 1 to execute a process of communicating with the quantum calculation function 200.

Note that it is suitable if the quantum program execution apparatus 100 further includes an input apparatus that receives key input and voice input from the user and an output apparatus, such as a display, that displays processing data.

In addition, at least a quantum calculation processing transform history holding unit 110, a quantum calculation processing transform algorithm holding unit 111, a program holding unit 112, a quantum calculation function characteristic information holding unit 113, a program-after-transformation holding unit 115, and a quantum calculation execution result holding unit 117 are formed in the storage apparatus 101 in addition to the program 102 for implementing the functions necessary for the quantum program execution apparatus 100 of the present embodiment.

Of these, the quantum calculation processing transform history holding unit 110 holds a history of applying a quantum process including operators to a transform algorithm to thereby reconstruct, that is, transform, the quantum process with operators that can be executed by the quantum calculation function 200. The history includes the quantum process before the transformation, the applied transform algorithm, the quantum process after the transformation, their evaluation results, and the like.

In addition, the quantum calculation processing transform algorithm holding unit 111 holds a transform algorithm for transforming a quantum process into an equivalent quantum process, in which part or all of the constituent operators are different. Note that it is assumed that the transform algorithm is provided in advance by the quantum calculation function 200 or the like.

In addition, the program holding unit 112 holds a program including a quantum process to be processed. It is assumed that the program held here is stored by a predetermined administrator or the like.

In addition, the quantum calculation function characteristic information holding unit 113 holds information, such as state maintenance time (coherence time), an error calculation function associated with time, operators that can be adopted, and error information and execution time of the operators, as characteristic information in the quantum calculation function 200.

In addition, the program-after-transformation holding unit 115 holds a program after transformation obtained by using the transform algorithm to equivalently transform the program (including the quantum process) before the transformation.

In addition, the quantum calculation execution result holding unit 117 holds information related to results of the execution of the program after transformation by the corresponding quantum calculation function 200 and evaluation of the results.

### <Flow Example>

Hereinafter, an actual procedure of a quantum computer utilization support method in the present embodiment will be described with reference to the drawings. Various actions corresponding to the quantum computer utilization support method described below are realized by a program read out to the memory or the like and executed by the quantum program execution apparatus 100. Furthermore, the program includes code for performing various actions described below.

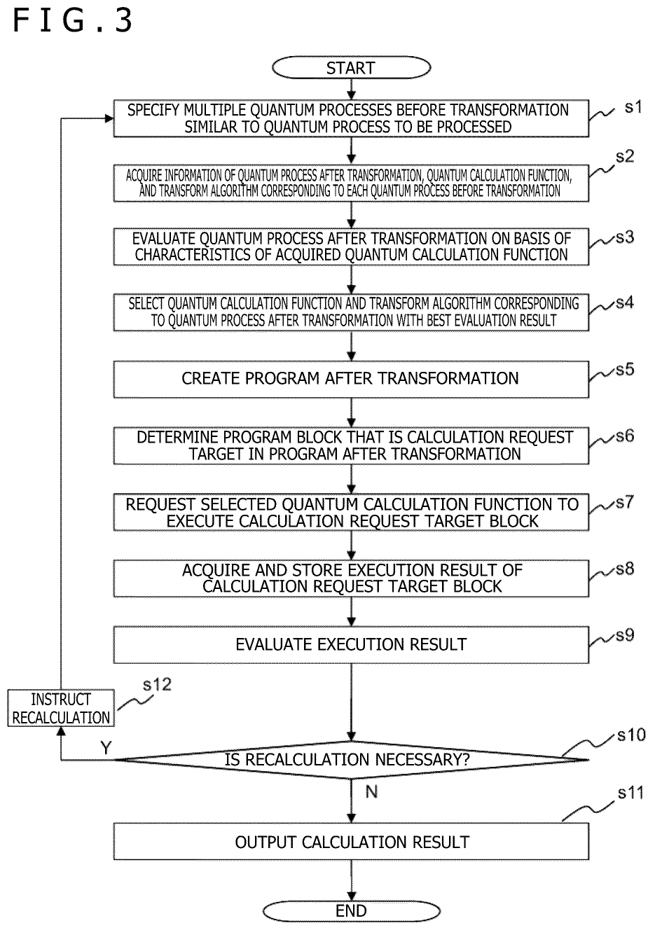

FIG. 3 is a diagram illustrating a flow example of the quantum computer utilization support method in the present embodiment. In this case, the program transform unit 114 of the quantum program execution apparatus 100 specifies, in the quantum calculation processing transform history holding unit 110, quantum processes to be processed in the past similar to the quantum process to be processed this time (example: quantum process including the program designated by the user and held in the program holding unit 112), in terms of at least one of the types and the number of operators included in the quantum processes and specifies the quantum processes to be processed in the past as a plurality of quantum processes before transformation (s1).

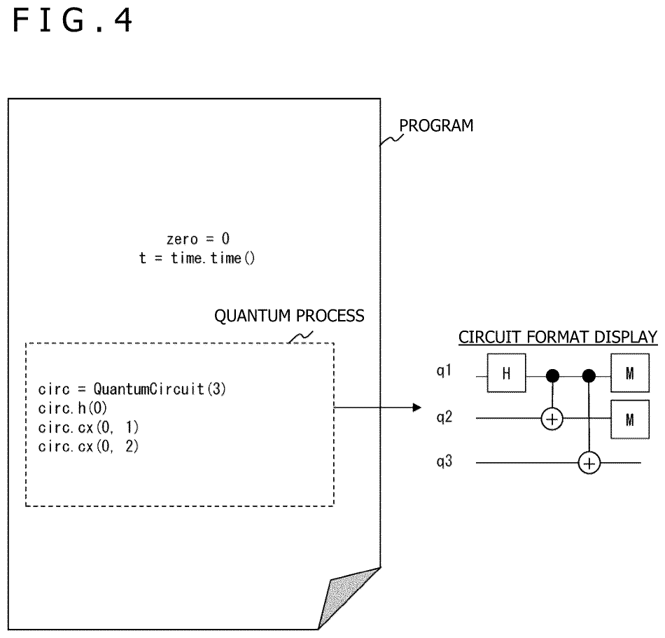

Note that it is assumed that the quantum process to be processed is included in a program. FIG. 4 illustrates an example of the program. As illustrated in FIG. 4, the quantum process is included in the program, and the quantum process can be expressed in a circuit format with a combination of operators.

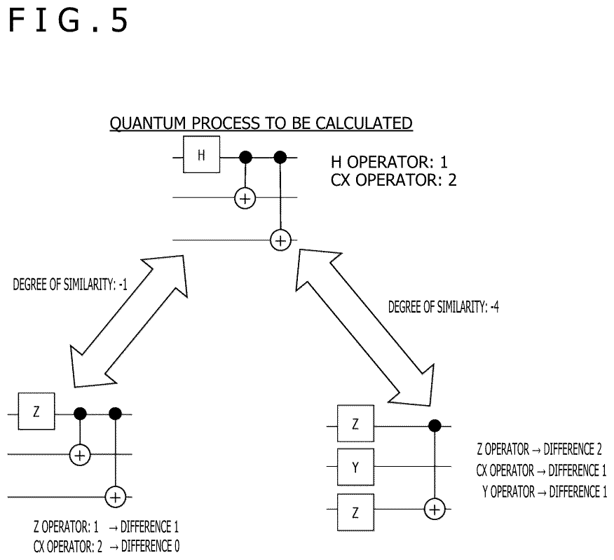

Therefore, to examine the similarity of quantum processes, it is assumed that the similarity is determined in terms of at least one of the types and the number of operators included in the quantum process as in an evaluation instance of the degree of similarity illustrated in FIG. 5.

For example, when the quantum process to be processed this time includes one H operator and two CX operators, it is determined that the degree of similarity of a quantum process including one Z operator and two CX operators is “−1” because the H operator and the Z operator are different. In addition, it is determined that the degree of similarity of a quantum process including two Z operators and one Y operator is “−4” because two Z operators, one CX operator, and one Y operator are different. The quantum program execution apparatus 100 specifies, as a quantum process before transformation, the quantum process with the largest degree of similarity as a result of the determination of the degree of similarity.

Note that it is suitable to choose a quantum process to be processed in the past that is different from the quantum process to be processed this time, in which the scale is small such that the theoretical value can be calculated but the types of operators are the same.

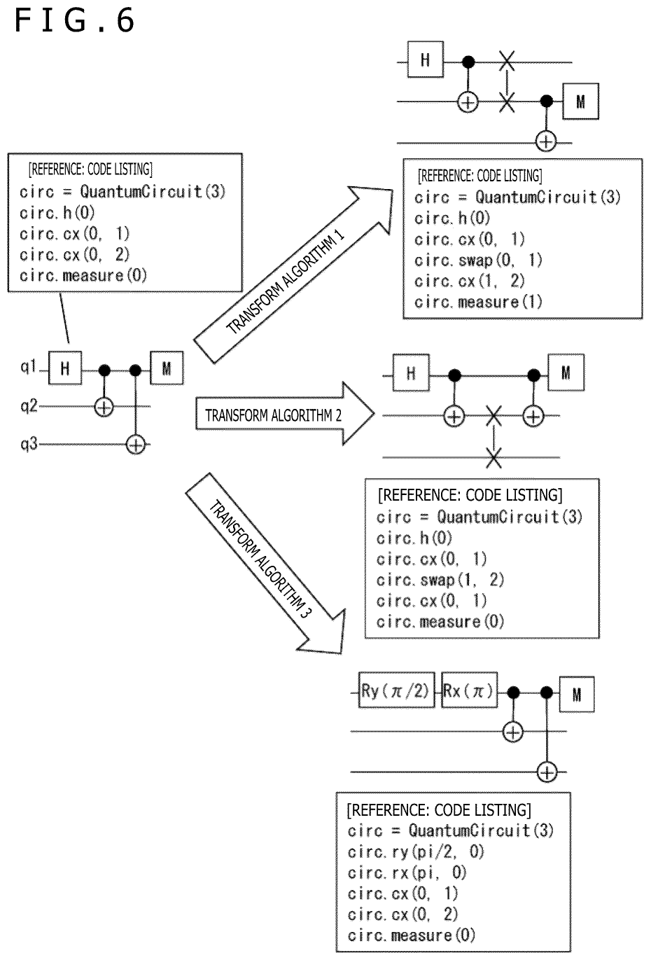

In addition, FIG. 6 illustrates a specific example of replacing the configuration of a quantum process with equivalent operators to transform the quantum process into another quantum process, that is, a transformation example with transform algorithms.

FIG. 6 illustrates a situation of using transform algorithms to transform a quantum process into three patterns, the quantum process including an H operator and an M operator in a quantum bit “q1” and including one CX operator in each of quantum bits “q2” and “q3.”

In addition, the program transform unit 114 of the quantum program execution apparatus 100 acquires, from the quantum calculation processing transform history holding unit 110, pieces of information regarding the quantum process after transformation, the quantum calculation function, and the transform algorithm corresponding to each of the plurality of quantum processes before transformation specified in s1 (s2).

Next, the program transform unit 114 of the quantum program execution apparatus 100 evaluates the quantum process after transformation acquired in s1, on the basis of the characteristics of the quantum calculation function in the information acquired in s2, that is, on the basis of quantum calculation function characteristic information 125 (s3).

In the evaluation, at least one of the size of calculation errors that occur when the quantum process after transformation is executed and the occurrence rate of the calculation errors is evaluated on the basis of at least one of operator error information related to errors that occur when the operators included in the quantum process are executed or state maintenance time information related to time that the quantum state can correctly be maintained indicated in the quantum calculation function characteristic information 125, for example.

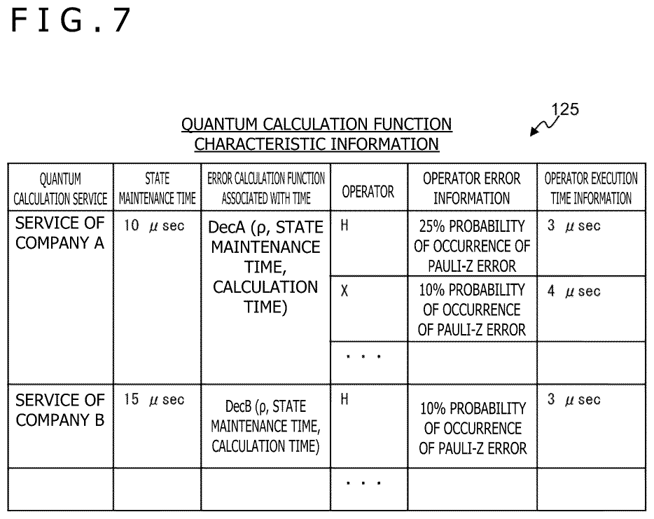

FIG. 7 is a diagram illustrating a configuration example of the quantum calculation function characteristic information 125 in the present embodiment. The quantum calculation function characteristic information 125 is held and managed by the quantum calculation function characteristic information holding unit 113. As illustrated in FIG. 7, the quantum calculation function characteristic information 125 is a table storing values, such as state maintenance time, an error calculation function associated with time, operators, operator error information, and operator execution time information, for each quantum calculation service as a quantum function.

For example, when a quantum process including one H operator and two X operators is executed by a quantum calculation service “service of company A,” the execution time of the H operator in the service of company A is “3 μsec,” and the execution time of the X operator is “4 μsec.” Therefore, it can be calculated that the total execution time is 3 μsec+4 μsec×2=11 μsec.

In addition, the operator error information, 10 μsec (state maintenance time), and 11 μsec (execution time=calculation time) are input to the “error calculation function associated with time” indicated in the quantum calculation function characteristic information 125 to evaluate at least one of the size of calculation errors that occur when the quantum process after transformation is executed and the occurrence rate of the calculation errors.

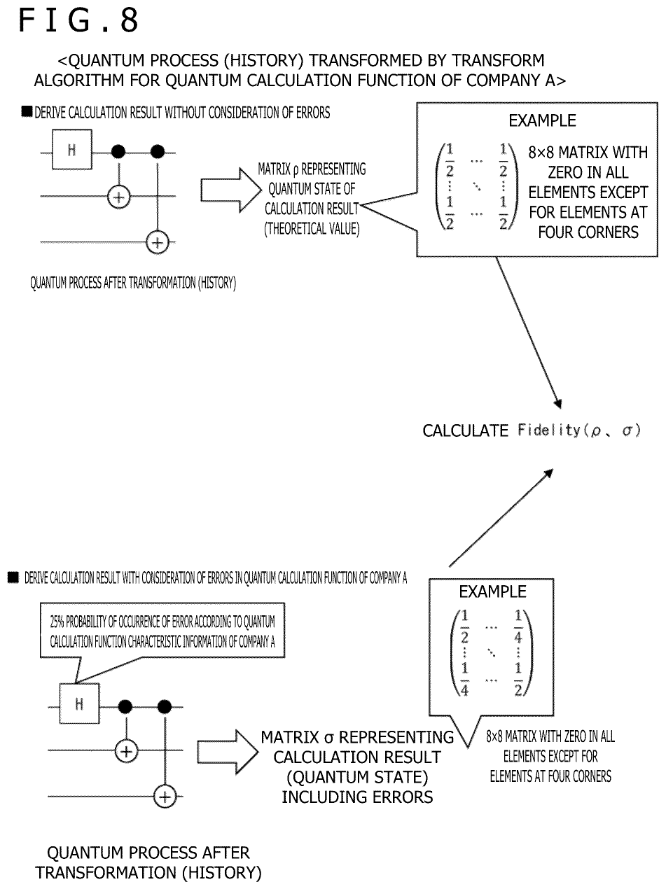

FIG. 8 is a diagram illustrating a selection method example of the quantum calculation function and the transform algorithm in the present embodiment. In this case, the quantum program execution apparatus 100 first derives a calculation result without consideration of errors, that is, derives a theoretical value. For example, the quantum program execution apparatus 100 calculates, for a quantum process generated in the past by the transform algorithm and including one H operator and two CX operators, a matrix ρ that is a calculation result without consideration of errors.

In addition, the quantum program execution apparatus 100 derives a calculation result with consideration of errors. For example, the quantum program execution apparatus 100 determines that a Pauli-Z error occurs with a probability of 25% based on the quantum calculation function characteristic information 125 when the quantum process generated in the past by the transform algorithm and including one H operator and two CX operators is executed by the quantum calculation function 200 of company A. The quantum program execution apparatus 100 calculates a matrix σ that is a calculation result including errors.

Although a classic computer may be used to calculate σ and ρ, ρ may be inversely calculated from σ on the basis of the characteristics of the quantum computer after σ is acquired by the actual machine. For example, a calibration matrix can be created on the basis of the quantum calculation function characteristic information 125, and ρ can be obtained by applying the created calibration matrix to σ acquired by using the quantum calculation function (for details, see the document (https://qiskit.org/documentation/locale/ja_JP/tutorials/noise/3 measurement_error_mitigation.html)).

In addition, the program transform unit 114 of the quantum program execution apparatus 100 gives ρ and σ to a function of fidelity to calculate the fidelity and specifies the quantum calculation function and the transform algorithm with large values of calculation results as suitable ones.

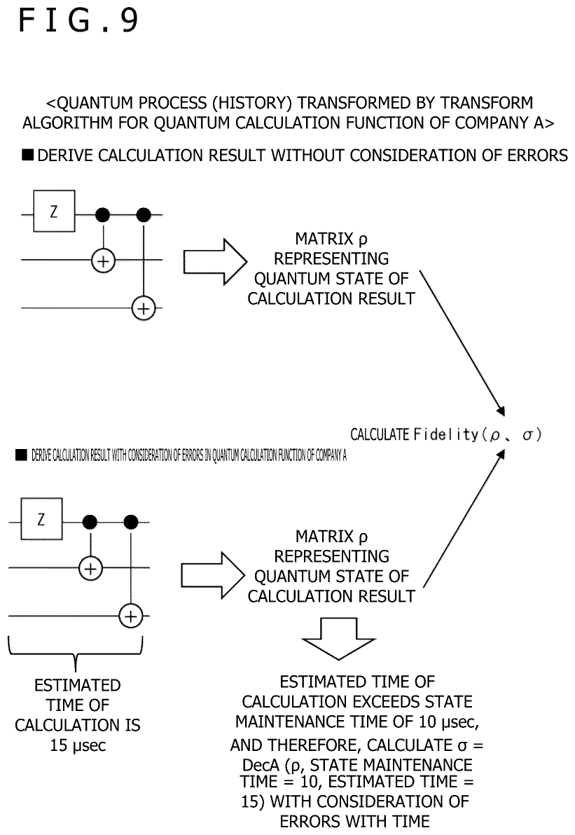

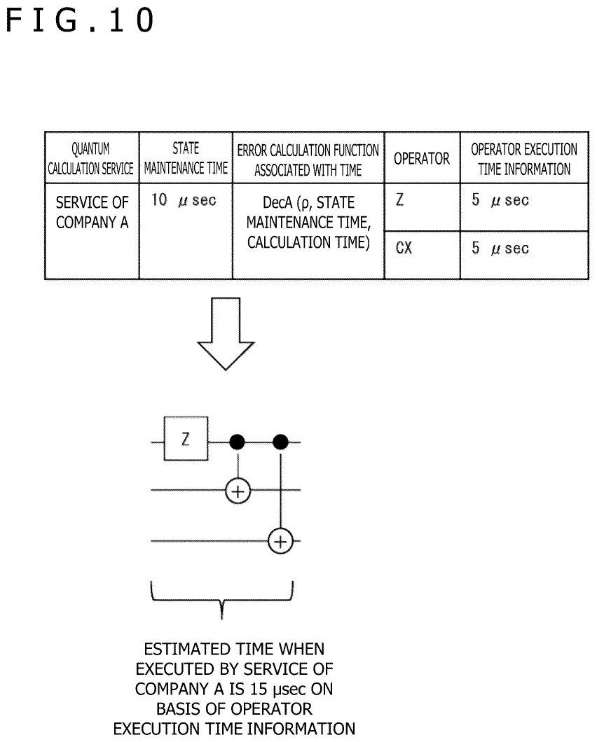

In addition, when the estimated time required for the calculation (see FIG. 10) is, for example, “15 μsec” as illustrated in FIG. 9, this exceeds the state maintenance time of 10 μsec, and therefore, the quantum program execution apparatus 100 calculates σ=DecA (ρ, state maintenance time=10, estimated time=15) with consideration of errors with the passage of time. Furthermore, the quantum program execution apparatus 100 gives ρ and σ to the function of fidelity to calculate the fidelity and specifies the quantum calculation function and the transform algorithm with large values of calculation results as suitable ones.

Next, the program transform unit 114 of the quantum program execution apparatus 100 selects, as a quantum calculation function and a transform algorithm to be used in the quantum process to be processed this time, the quantum calculation function and the transform algorithm corresponding to the quantum process after transformation with the best result of evaluation in s3, that is, the quantum calculation function and the transform algorithm with high effectiveness (s4).

In addition, the program transform unit 114 of the quantum program execution apparatus 100 applies the transform algorithm selected in s4, in relation to the quantum process included in the program to be processed this time, to thereby create a program after transformation as illustrated in FIG. 6, and stores it in the program-after-transformation holding unit 115 (s5).

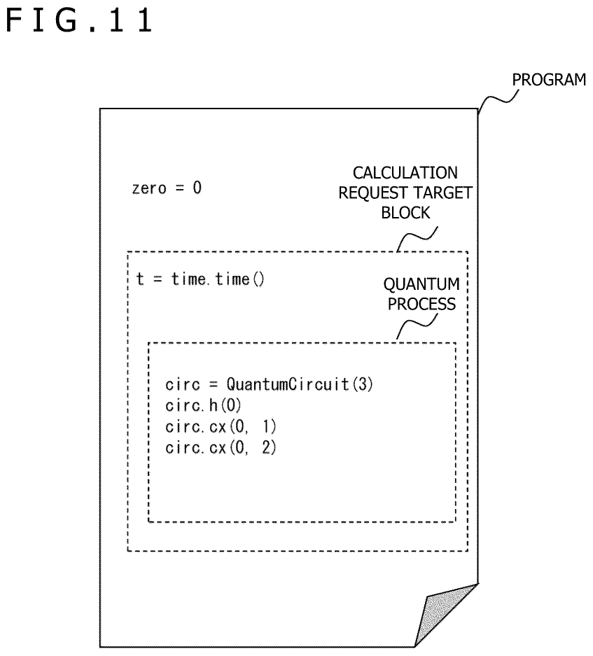

Next, the program transform unit 114 of the quantum program execution apparatus 100 determines, as a calculation request target block (see FIG. 11), a program block that is a calculation request target for the quantum calculation function 200 selected in s4 in the program after transformation obtained in s5 (s6).

In addition, the program execution unit 116 of the quantum program execution apparatus 100 requests the quantum calculation function 200 selected in s4 to execute the calculation request target block determined in s6 (s7).

Next, the program execution unit 116 of the quantum program execution apparatus 100 acquires an execution result of the calculation request target block from the quantum calculation function 200 requested in s7 and stores it in the quantum calculation execution result holding unit 117 (s8).

Next, the quantum calculation execution result evaluation unit 118 of the quantum program execution apparatus 100 evaluates the execution result obtained from the quantum calculation function 200 in s8 (s9).

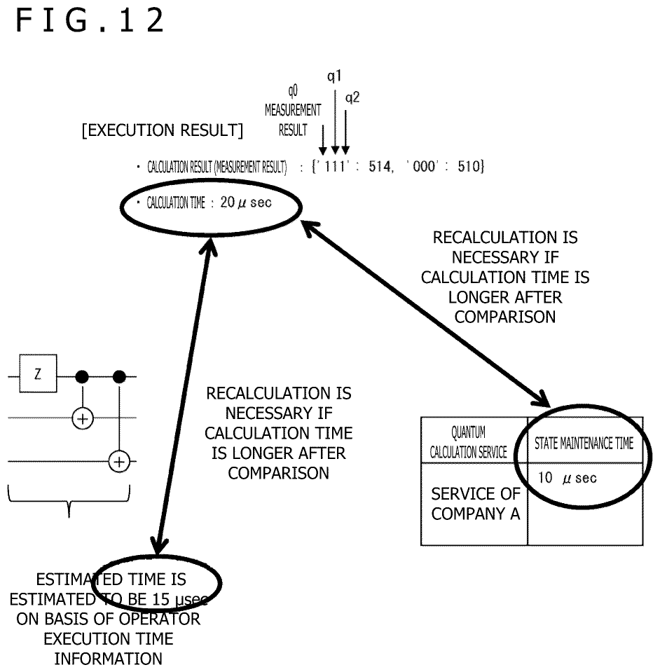

The evaluation is performed by comparing the calculation time required for the calculation of the quantum process after transformation (“20 μsec” in FIG. 12) and the state maintenance time information (“10 μsec” in FIG. 12) included in the execution result.

Alternatively, the estimated time required for the execution of the quantum process after transformation (“15 μsec” in FIG. 12) can be computed on the basis of the operator execution time information indicated in the quantum calculation function characteristic information, the operator execution time information representing the time required for the execution of the operators included in the quantum process. The estimated time and the state maintenance time information (“10 μsec” in FIG. 12) can be compared to perform the evaluation.

Note that the quantum program execution apparatus 100 associates the quantum process to be processed this time, the quantum process after transformation related to the quantum process, and the execution result (and the evaluation result of the execution result) and registers them in the quantum calculation execution result holding unit 117 of the storage apparatus 101 to use them in subsequent evaluation.

In addition, if the calculation time (“20 μsec” in FIG. 12) or the estimated time (“15 μsec” in FIG. 12) is shorter than the state maintenance time information (“10 μsec” in FIG. 12) in the result of the evaluation in s9, the quantum calculation execution result evaluation unit 118 of the quantum program execution apparatus 100 determines whether recalculation is necessary, that is, determines whether recalculation is necessary according to whether the calculation result is reliable (s10).

As a result of the determination above, if the quantum calculation execution result evaluation unit 118 of the quantum program execution apparatus 100 determines that the calculation result is reliable and the recalculation is not necessary (s10: N), the quantum calculation execution result evaluation unit 118 transmits the calculation result to the program execution unit 116 (s11) and requests the quantum calculation function 200 for the process, thus ending the present flow.

Conversely, if the quantum calculation execution result evaluation unit 118 of the quantum program execution apparatus 100 determines that the calculation result is not reliable so that recalculation is necessary as a result of the determination above (s10: Y), the quantum calculation execution result evaluation unit 118 transmits an instruction of recalculation to the program transform unit 114 (s12) and executes the present flow again.

Although an embodiment and the like for realizing the present invention have been specifically described, the present invention is not limited to these but can be changed in various ways without departing from the scope of the present invention.

The present embodiment can support selecting a combination of a quantum calculation function and a transform algorithm for obtaining a calculation result with high fidelity in quantum calculation processing.

At least the following becomes apparent from the description of the present specification. That is, the operation apparatus in the quantum computer utilization support system of the present embodiment may specify the quantum process before transformation similar to the quantum process to be processed, in terms of at least one of the types and the number of operators included in the quantum process.

Thus, the similarity can be determined based on, for example, whether there is an operator that is easily directly affected by the characteristics of the quantum calculation function, and this can make a similarity determination with better accuracy and can support appropriately selecting a combination of a quantum calculation function and a transform algorithm for obtaining a calculation result with high fidelity in the quantum calculation processing.

In addition, the operation apparatus in the quantum computer utilization support system of the present embodiment may further execute a process of applying the transform algorithm in relation to the quantum process to be processed included in a predetermined program to thereby create a program after transformation, determining, as a calculation request target block, a program block that is a calculation request target for the quantum calculation function in the program after transformation, and requesting the quantum calculation function to execute the calculation request target block, and a process of acquiring an execution result of the calculation request target block from the quantum calculation function and determining whether recalculation is necessary on the basis of an evaluation result of the execution result.

In so doing, the operation apparatus in the quantum computer utilization support system of the present embodiment can support selecting a combination of a quantum calculation function and a transform algorithm for obtaining a calculation result with high fidelity in the quantum calculation processing regarding the program including the quantum calculation.

In addition, the operation apparatus in the quantum computer utilization support system of the present embodiment may evaluate the quantum process after transformation acquired from the history, on the basis of at least one of operator error information related to errors that occur when the operators included in the quantum process are executed, the operator error information being indicated in the information regarding the quantum calculation function and being characteristic information regarding the quantum calculation function, or state maintenance time information related to time that the quantum state can correctly be maintained.

As a result, the quantum process after transformation can be evaluated at higher accuracy, and this can also support selecting a combination of a quantum calculation function and a transform algorithm for obtaining a calculation result with high fidelity in the quantum calculation processing.

In addition, the operation apparatus in the quantum computer utilization support system of the present embodiment may evaluate at least one of the size of the calculation errors that occur when the quantum process after transformation is executed or the occurrence rate of the calculation errors, on the basis of at least one of the operator error information or the state maintenance time information.

As a result, the quantum process after transformation can be evaluated at even higher accuracy, and this can also support selecting a combination of a quantum calculation function and a transform algorithm for obtaining a calculation result with high fidelity in the quantum calculation processing.

In addition, the operation apparatus in the quantum computer utilization support system of the present embodiment may compare the calculation time required for the calculation of the quantum process after transformation and the state maintenance time information included in the execution result to thereby evaluate the execution result.

As a result, the execution result can be evaluated at higher accuracy, and this can also support selecting a combination of a quantum calculation function and a transform algorithm for obtaining a calculation result with high fidelity in the quantum calculation processing.

In addition, the operation apparatus in the quantum computer utilization support system of the present embodiment may associate and register the quantum process to be processed, the quantum process after transformation related to the quantum process, and the execution result in the storage apparatus and use them in subsequent evaluation.

As a result, the quantum process after transformation and the execution result can appropriately be accumulated to support selecting a combination of a quantum calculation function and a transform algorithm for obtaining a calculation result with high fidelity in the quantum calculation processing.

In addition, the operation apparatus in the quantum computer utilization support system of the present embodiment may calculate estimated time required for the execution of the quantum process after transformation on the basis of operator execution time information included in the characteristic information regarding the quantum calculation function and representing time required for the execution of the operators included in the quantum process and may compare the estimated time and the state maintenance time information to thereby evaluate the execution result.

As a result, the evaluation accuracy of the execution result becomes more suitable, and this can support selecting a combination of a quantum calculation function and a transform algorithm for obtaining a calculation result with high fidelity in the quantum calculation processing.

In addition, the information processing apparatus in the quantum computer utilization support method of the present embodiment may specify the quantum process before transformation similar to the quantum process to be processed, in terms of at least one of the types and the number of operators included in the quantum process.

In addition, the information processing apparatus in the quantum computer utilization support method of the present embodiment may further execute a process of applying the transform algorithm in relation to the quantum process to be processed included in a predetermined program to thereby create a program after transformation, determining, as a calculation request target block, a program block that is a calculation request target for the quantum calculation function in the program after transformation, and requesting the quantum calculation function to execute the calculation request target block, and a process of acquiring an execution result of the calculation request target block from the quantum calculation function and determining whether recalculation is necessary on the basis of an evaluation result of the execution result.

In addition, the information processing apparatus in the quantum computer utilization support method of the present embodiment may evaluate the quantum process after transformation acquired from the history, on the basis of at least one of operator error information related to errors that occur when the operators included in the quantum process are executed, the operator error information being indicated in the information regarding the quantum calculation function and being characteristic information regarding the quantum calculation function, or state maintenance time information related to time that the quantum state can correctly be maintained.

In addition, the information processing apparatus in the quantum computer utilization support method of the present embodiment may evaluate at least one of the size of the calculation errors that occur when the quantum process after transformation is executed or the occurrence rate of the calculation errors on the basis of at least one of the operator error information or the state maintenance time information.

In addition, the information processing apparatus in the quantum computer utilization support method of the present embodiment may compare the calculation time required for the calculation of the quantum process after transformation and the state maintenance time information included in the execution result to thereby evaluate the execution result.

In addition, the information processing apparatus in the quantum computer utilization support method of the present embodiment may associate and register the quantum process to be processed, the quantum process after transformation related to the quantum process, and the execution result in the storage apparatus and use them in subsequent evaluation.

In addition, the information processing apparatus in the quantum computer utilization support method of the present embodiment may calculate estimated time required for the execution of the quantum process after transformation on the basis of operator execution time information included in the characteristic information regarding the quantum calculation function and representing time required for the execution of the operators included in the quantum process and may compare the estimated time and the state maintenance time information to thereby evaluate the execution result.

### DESCRIPTION OF REFERENCE NUMERALS

1: Network
10: Quantum computer utilization support system
100: Quantum program execution apparatus (information processing apparatus)
101: Storage apparatus
102: Program
103: Memory
104: Operation apparatus
105: Communication apparatus
110: Quantum calculation processing transform history holding unit
111: Quantum calculation processing transform algorithm holding unit
112: Program holding unit
113: Quantum calculation function characteristic information holding unit
114: Program transform unit
115: Program-after-transformation holding unit
116: Program execution unit
117: Quantum calculation execution result holding unit
118: Quantum calculation execution result evaluation unit
125: Quantum calculation function characteristic information
200: Quantum calculation function

1. A quantum computer utilization support system comprising:
a storage apparatus that holds information regarding a quantum calculation function for executing a quantum process, an operator that can be executed by the quantum calculation function, a transform algorithm for transforming the quantum process into an equivalent quantum process after transformation including the operator, and a history of using the transform algorithm to transform a predetermined quantum process executed by a predetermined quantum calculation function into a quantum process after transformation; and
an operation apparatus that executes a process of specifying, as quantum processes before transformation, a plurality of predetermined quantum processes similar to a quantum process to be processed from the history and acquiring information regarding the quantum process after transformation, the quantum calculation function, and the transform algorithm corresponding to each of the plurality of specified quantum processes before transformation from the history, a process of evaluating the quantum process after transformation acquired from the history, on a basis of characteristics of the quantum calculation function in the information acquired from the history, and a process of selecting, as a quantum calculation function and a transform algorithm to be used in the quantum process to be processed, the quantum calculation function and the transform algorithm corresponding to the quantum process after transformation with a best result of the evaluation.

2. The quantum computer utilization support system according to claim 1, wherein
the operation apparatus specifies the quantum process before transformation similar to the quantum process to be processed, in terms of at least one of a type and a number of operators included in the quantum process.

3. The quantum computer utilization support system according to claim 1, wherein
the operation apparatus further executes
a process of applying the transform algorithm in relation to the quantum process to be processed included in a predetermined program to thereby create a program after transformation, determining, as a calculation request target block, a program block that is a calculation request target for the quantum calculation function in the program after transformation, and requesting the quantum calculation function to execute the calculation request target block, and
a process of acquiring an execution result of the calculation request target block from the quantum calculation function and determining whether recalculation is necessary on a basis of an evaluation result of the execution result.

4. The quantum computer utilization support system according to claim 3, wherein
the operation apparatus evaluates the quantum process after transformation acquired from the history on a basis of at least one of operator error information related to an error that occurs when the operator included in the quantum process is executed, the operator error information being indicated in the information regarding the calculation quantum function and being characteristic information regarding the quantum calculation function, or state maintenance time information related to time that a quantum state can correctly be maintained.

5. The quantum computer utilization support system according to claim 4, wherein
the operation apparatus evaluates at least one of a size of a calculation error that occurs when the quantum process after transformation is executed and an occurrence rate of the calculation error, on a basis of at least one of the operator error information or the state maintenance time information.

6. The quantum computer utilization support system according to claim 4, wherein
the operation apparatus compares calculation time required for calculation of the quantum process after transformation and the state maintenance time information included in the execution result to thereby evaluate the execution result.

7. The quantum computer utilization support system according to claim 3, wherein
the operation apparatus associates and registers the quantum process to be processed, the quantum process after transformation related to the quantum process, and the execution result in the storage apparatus and use them in subsequent evaluation.

8. The quantum computer utilization support system according to claim 4, wherein
the operation apparatus calculates estimated time required for execution of the quantum process after transformation, on a basis of operator execution time information included in the characteristic information regarding the quantum calculation function and representing time required for execution of the operator included in the quantum process and compares the estimated time and the state maintenance time information to thereby evaluate the execution result.

9. A quantum computer utilization support method executed by an information processing apparatus, the information processing apparatus being configured to:
hold, in a storage apparatus, information regarding a quantum calculation function for executing a quantum process, an operator that can be executed by the quantum calculation function, a transform algorithm for transforming the quantum process into an equivalent quantum process after transformation including the operator, and a history of using the transform algorithm to transform a predetermined quantum process executed by a predetermined quantum calculation function into a quantum process after transformation, and
execute a process of specifying, as quantum processes before transformation, a plurality of predetermined quantum processes similar to a quantum process to be processed from the history and acquiring information regarding the quantum process after transformation, the quantum calculation function, and the transform algorithm corresponding to each of the plurality of specified quantum processes before transformation from the history, a process of evaluating the quantum process after transformation acquired from the history on a basis of characteristics of the quantum calculation function in the information acquired from the history, and a process of selecting, as a quantum calculation function and a transform algorithm to be used in the quantum process to be processed, the quantum calculation function and the transform algorithm corresponding to the quantum process after transformation with a best result of the evaluation.

10. The quantum computer utilization support method according to claim 9, wherein
the information processing apparatus specifies the quantum process before transformation similar to the quantum process to be processed, in terms of at least one of a type and a number of operators included in the quantum process.

11. The quantum computer utilization support method according to claim 9, wherein
the information processing apparatus further executes
a process of applying the transform algorithm in relation to the quantum process to be processed included in a predetermined program to thereby create a program after transformation, determining, as a calculation request target block, a program block that is a calculation request target for the quantum calculation function in the program after transformation, and requesting the quantum calculation function to execute the calculation request target block, and
a process of acquiring an execution result of the calculation request target block from the quantum calculation function and determining whether recalculation is necessary on a basis of an evaluation result of the execution result.

12. The quantum computer utilization support method according to claim 11, wherein
the information processing apparatus evaluates the quantum process after transformation acquired from the history on a basis of at least one of operator error information related to an error that occurs when the operator included in the quantum process is executed, the operator error information being indicated in the information regarding the quantum calculation function and being characteristic information regarding the quantum calculation function, or state maintenance time information related to time that the quantum state can correctly be maintained.

13. The quantum computer utilization support method according to claim 12, wherein
the information processing apparatus evaluates at least one of a size of a calculation error that occurs when the quantum process after transformation is executed or an occurrence rate of the calculation error, on a basis of at least one of the operator error information or the state maintenance time information.

14. The quantum computer utilization support method according to claim 12, wherein
the information processing apparatus compares calculation time required for calculation of the quantum process after transformation and the state maintenance time information included in the execution result to thereby evaluate the execution result.

15. The quantum computer utilization support method according to claim 11, wherein
the information processing apparatus associates and registers the quantum process to be processed, the quantum process after transformation related to the quantum process, and the execution result in the storage apparatus and use them in subsequent evaluation.

16. The quantum computer utilization support method according to claim 12, wherein
the information processing apparatus calculates estimated time required for execution of the quantum process after transformation, on a basis of operator execution time information included in the characteristic information regarding the quantum calculation function and representing time required for execution of the operator included in the quantum process and compares the estimated time and the state maintenance time information to thereby evaluate the execution result.
